(19) United States
(12) Patent Application Publication
(10) Pub. No.: US 2009/0157508 A1
(43) Pub. Date: Jun. 18, 2009

(54) SYSTEM AND METHOD FOR INTERACTIVE ADVERTISING CROSS-REFERENCE TO RELATED APPLICATIONS

(76) Inventors: SHANNON WAYNE ILLINGWORTH, Yorba Linda, CA (US); James Winsor, Corona, CA (US)

Correspondence Address: VENABLE LLP, P.O. BOX 34385, WASHINGTON, DC, 20043-9998, US

(21) Appl. No.: 12/179,238

(22) Filed: Jul. 24, 2008

Related U.S. Application Data
(60) Provisional application No. 60/935,045, filed on Jul. 24, 2007.

(51) Int. Cl. G06Q 30/00; G06Q 40/00; G06Q 90/00

(52) U.S. Cl. 705/14; 705/1; 705/35

(57) ABSTRACT

An interactive advertising application and complementary hardware/network product to provide a unique solution for potential clients, users, and consumers to interact to a specific network of supplied information (e.g., advertising, branding, interacting, etc.) via a secure or unsecured network.

### CROSS-REFERENCE TO RELATED APPLICATIONS

This application claims the benefit under 35 U.S.C. § 119(e)(1) of Ser. No. 60/935,045, filed on Jul. 24, 2007 and entitled “System And Method For Interactive Advertising.”

This application also claims the benefit under 35 U.S.C. § 120 of the following co-pending and commonly assigned: Ser. No. 11/588,420, filed on Oct. 27, 2006 and entitled “Multimedia System And Method For Controlling Vending Machines,” which in turn claims the benefit of Ser. No. 60/730,368, filed on Oct. 27, 2005 and entitled “Multimedia System And Method For Controlling Vending Machines;” and Ser. No. 11/588,422, filed on Oct. 27, 2006 and entitled “Wireless Management Of Remote Vending Machines,” which in turn claims the benefit of Ser. No. 60/730,369, filed on Oct. 27, 2005 and entitled “Multimedia System And Method For Controlling Vending Machines.”

Each of the above cited patents and patent applications is incorporated herein by reference in its entirety.

### BACKGROUND OF THE INVENTION

1. Field of the Invention

The present invention in its disclosed embodiments is related generally to automated vending machines, and more particularly to management and control of such vending machines, including any advertisements which may be displayed thereon.

2. Background

Disclosed herein is an interactive advertising application and complementary hardware/network product to provide a unique solution for potential clients or users to interact to a specific network of supplied information (e.g., advertising, branding, interacting, etc.) via a secure or unsecured network to a known and developed server.

This product/technique was designed and developed specifically to allow for the direct interaction for and to information that is supplied through an existing telephone switch based infrastructure.

Previously, Automated Vending Technologies (“AVT”) developed a digital signage known as AVTDS that offers the public an efficient and unique medium to advertise on a 7-inch wide touch screen panel through a secure VPN network. AVTDS is the only exclusively software product that features updates made possible from a USB thumb drive, cell modem or Internet.

AVT has taken the base advertising hardware/software product and developed a product adaptable to the telephone industry, which adds a level of interaction based on touch (or other interactive means, e.g., keyboard, display message, RSS feed, etc.). Viewers may be rewarded either with discounts and/or promotional deals depending on the touched advertisement (e.g., by a simple instruction displayed on the screen explaining the steps to viewers about acquiring their rewards). In addition, designated hot-spot locations allow viewers to use wireless internet within the location's range to aid them in acquiring their reward quicker. Specific advertisements may be downloaded and displayed on the touch screen based on where the location is. These features may be available from the administrator side, which is an application with user-friendly interfaces to allow an end-user to preview, download, update, schedule and many more features to an individual location.

Below is an overview of the direct interactivity a client using the integrated touch screen (or other interactive means, e.g., keyboard, display message, RSS feed, etc.) based system to interact with the supplied or displayed information on the LCD display back over the internet and then tunneled through a Virtual Private Network (VPN) to a secure server where the interactive feedback is received, processed and corresponding information is sent back to the client (or user) in one or more ways.

The smart technology integrated into each telephone base may also have the appropriate hardware to make that specific station or “node” be known as a “hot spot.” The hot spot is another means to allow interactivity to the VPN network through free or fee-based communication from the user's portable device such as a telephone (e.g., a cell phone or smart phone), PC (e.g., laptop), personal digital assistant (PDA), or other portable electronic device capable of linking to the hot spot by means of cable, wireless, infrared radio frequency or other. The user may now form a dependency for use of the known hot spot and become a habitual user of said technology and services.

### SUMMARY

One embodiment includes a system for managing interactive advertisements, comprising: a plurality of remote vending machines; an enterprise control center; a network coupling said enterprise control center and the plurality of remote vending machines; a touch screen associated with each of the plurality of vending machines; and means for displaying a plurality of advertisements on said touch screen.

Further features of the embodiments, as well as the structure and operation of various embodiments, are described in detail below with reference to the accompanying drawings.

### BRIEF DESCRIPTION OF THE DRAWINGS

Embodiments will now be described in connection with the associated drawings, in which:

FIG. 1 depicts a block diagram of a multimedia system and method for controlling a plurality of vending machines according to one embodiment of the present invention;

FIG. 2 depicts a block diagram of a multimedia system and method for controlling a plurality of vending machines according to another embodiment of the present invention;

FIG. 3 depicts a block diagram of a multimedia system and method for controlling a plurality of vending machines according to yet another embodiment of the present invention;

FIG. 4 depicts a block diagram of a system for interactive advertising according to an embodiment of the present invention;

FIG. 5 depicts a block diagram of advertisement content flow according to one embodiment of the present invention;

FIGS. 6A and 6B depict block diagrams of advertisement content flow according to alternative embodiments of the present invention;

FIG. 7 depicts a block diagram of a promotion according to one embodiment of the present invention;

FIG. 8 depicts a block diagram of a promotion according to another embodiment of the present invention;

FIG. 9 depicts an exemplary flowchart for managing the advertisement content flow and promotions according to one embodiment of the present invention; and

FIGS. 10A, 10B, and 10C depict exemplary flowcharts for managing the advertisement content flow and promotions according to one embodiment of the present invention.

### DETAILED DESCRIPTION OF THE EMBODIMENTS

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without parting from the spirit and scope of the embodiments. It is to be understood that each specific element includes all technical equivalents that operate in a similar manner to accomplish a similar purpose. The examples and embodiments described herein are non-limiting examples.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

In the following description and claims, the terms “computer program medium” and “computer readable medium” may be used to generally refer to media such as, e.g., but not limited to removable storage drive, a hard disk installed in hard disk drive, and signals, etc. These computer program products may provide software to computer system. Embodiments of the invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may further include apparatuses and systems for performing the operations described herein. An apparatus or system may be specially constructed for the desired purposes, or it may comprise a general-purpose device selectively activated or reconfigured by a program stored in the device.

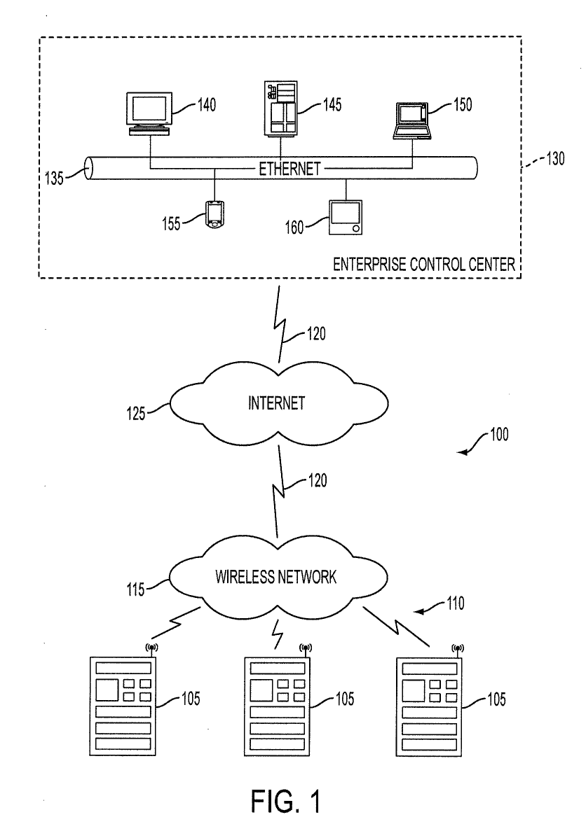

Referring now to the drawings, wherein like reference numerals and characters represent like or corresponding parts and steps throughout each of the several views, there is shown in FIG. 1 a block diagram of a multimedia system 100 for controlling a plurality of vending machines 105 according to one embodiment of the present invention. Each of the plurality of vending machines 105 is wirelessly coupled by a first coupling means 110 to a wireless network 115. The wireless network 115, in turn, is coupled by a second coupling means 120 to a large-scale network such as the Internet 125. It should be understood that the foregoing use of the term “Internet” is not intended to limit the present invention to a network also known as the World Wide Web. Embodiments according to the present invention may likewise include intranets, extranets, Virtual Private Networks (VPNs), and the like.

Such second coupling means 120 may also be used to couple communications from the plurality of vending machines 105, through the wireless network 115 and Internet 125, to an enterprise control center 130. In turn, the enterprise control center may comprise a local area network of computers coupled together by way of an Ethernet 135. Such computers may comprise a desktop computer or workstation 140, a tower computer or server 145, a laptop computer 150, a personal digital assistant (PDA) 155, or a pen-based notebook 160.

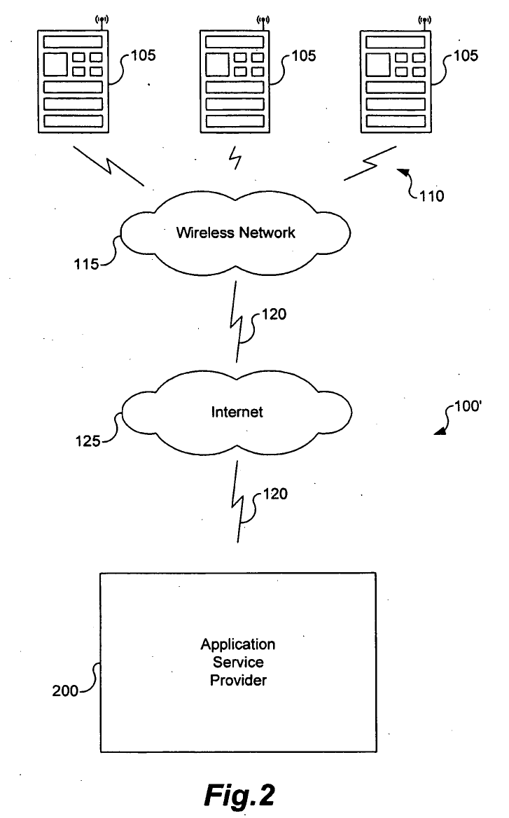

Referring now to FIG. 2, there is shown a block diagram of a multimedia system 100′ for controlling a plurality of vending machines 105 according to another embodiment of the present invention. Each of the plurality of vending machines 105, like the system 100 shown in FIG. 1, is wirelessly coupled by a first coupling means 110 to a wireless network 115.

The wireless network 115, in turn, is coupled by a second coupling means 120 to a large-scale network such as the Internet 125. In the embodiment according to FIG. 2, however, system 100′ is adapted to be controlled by an application service provider (ASP) means 200. Further details regarding one embodiment of the ASP means 200 may be found in the aforementioned Ser. No. 11/588,420 and Ser. No. 11/588,422.

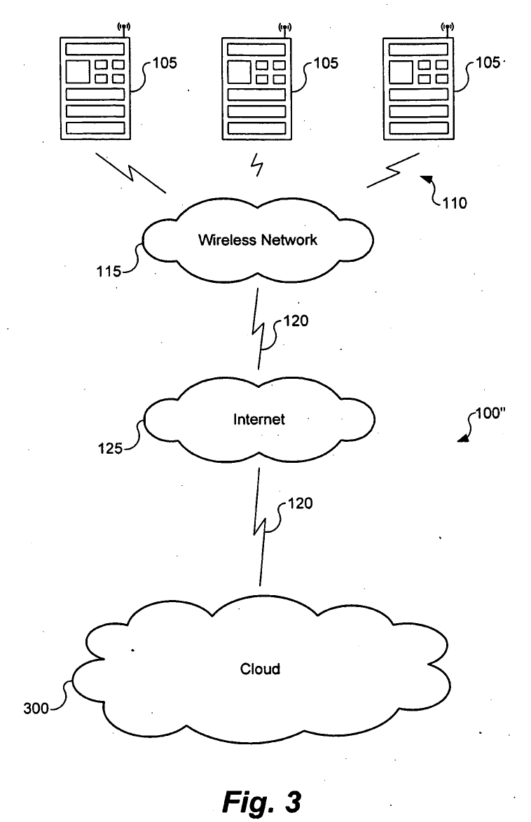

Referring now to FIG. 3, there is shown a block diagram of a multimedia system 100″ for controlling a plurality of vending machines 105 according to another embodiment of the present invention. Each of the plurality of vending machines 105, like the system 100 shown in FIG. 1, is wirelessly coupled by a first coupling means 110 to a wireless network 115.

The wireless network 115, in turn, is coupled by a second coupling means 120 to a large-scale network such as the Internet 125. In the embodiment according to FIG. 3, however, system 100″ is adapted to be controlled by cloud computing means 300.

As is known, the term “cloud computing” refers to a computing paradigm in which tasks are assigned to a combination of connections, software and services accessed over a network. This network of servers and connections is collectively known as “the cloud.” Computing at the scale of the cloud allows users to access supercomputer-level power. Using a thin client or other access point (e.g., an iPhone, BlackBerry or laptop), users can reach into the cloud for resources as they need them. For this reason, cloud computing has also been described as “on-demand computing.”

This vast processing power is made possible though distributed, large-scale cluster computing, often in concert with server virtualization software (e.g., Xen) and parallel processing. Cloud computing can be contrasted with the traditional desktop computing model, where the resources of a single desktop computer are used to complete tasks, and an expansion of the client/server model. To paraphrase Sun Microsystems' famous adage, in cloud computing the network becomes the supercomputer.

Cloud computing is often used to sort through enormous amounts of data. In fact, Google has an initial edge in cloud computing precisely because of its need to produce instant, accurate results for millions of incoming search inquires every day, parsing through the terabytes of Internet data cached on its servers. Google's approach has been to design and manufacture hundreds of thousands of its own servers from commodity components, connecting relatively inexpensive processors in parallel to create an immensely powerful, scalable system. Google Apps, Maps and Gmail are all based in the cloud. Other companies have already created Web-based operating systems that collect online applications into Flash-based graphic user interfaces (GUIs), often using a look and feel intentionally quite similar to Windows. Hundreds of organizations are already offering free Web services in the cloud.

In many ways, however, cloud computing is simply a buzzword used to repackage grid computing and utility computing, both of which are known to those of ordinary skill in the art and have existed for decades. Like grid computing, cloud computing requires the use of software that can divide and distribute components of a program to thousands of computers. New advances in processors, virtualization technology, disk storage, broadband Internet access and fast, inexpensive servers have all combined to make cloud computing a compelling paradigm. Cloud computing allows users and companies to pay for and use the services and storage that they need, when they need them and, as wireless broadband connection options grow, where they need them. Customers can be billed based upon server utilization, processing power used or bandwidth consumed. As a result, cloud computing has the potential to upend the software industry entirely, as applications are purchased, licensed and run over the network instead of a user's desktop. This shift will put data centers and their administrators at the center of the distributed network, as processing power, electricity, bandwidth and storage are all managed remotely.

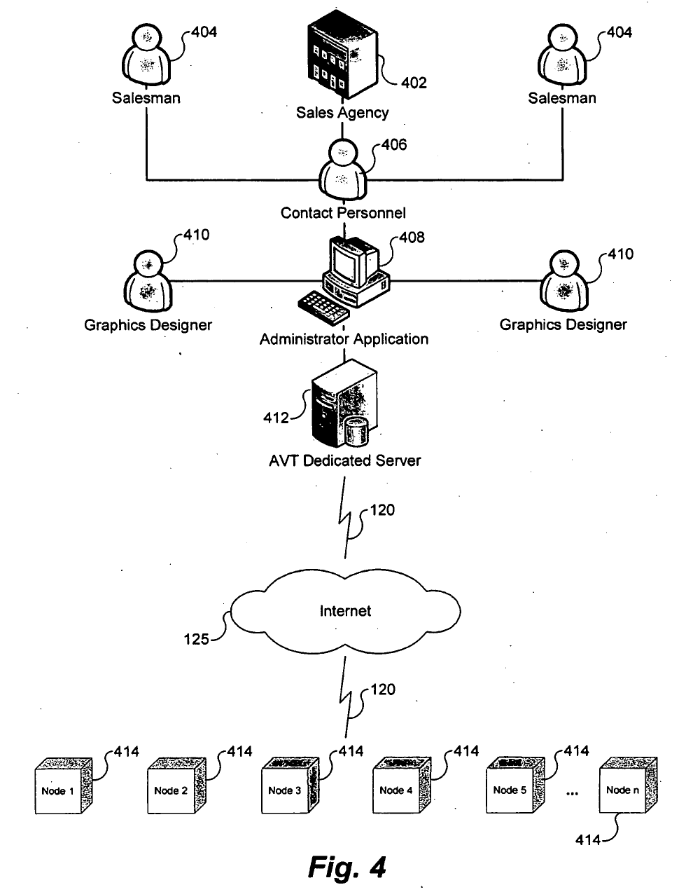

Systems according to embodiments of the present invention may be generally comprised in the manner shown in FIG. 4. A sales agency 402 with one or more salesmen 404 are coupled for communication to an administrator application 408 through contact personnel 406. Advertisements are created by such salesmen 404 with or without the assistance of one or more graphics designers 410. Such advertisements are then mounted for distribution by the systems described herein to a dedicated server 412 within the enterprise control center (not shown in FIG. 4). Thereafter, each of a plurality of nodes 414 is wirelessly coupled to the server 412 by suitable means as described herein above to a large-scale network such as the Internet 125. It should be appreciated that each of the advertising nodes 414 may comprise a vending machine as shown and described in the aforementioned application Ser. No. 11/588,420 and Ser. No. 11/588,422, and in Ser. No. 11/976,311 for a “Vend Sensing System”, which is incorporated herein by reference. They may also comprise a pay telephone.

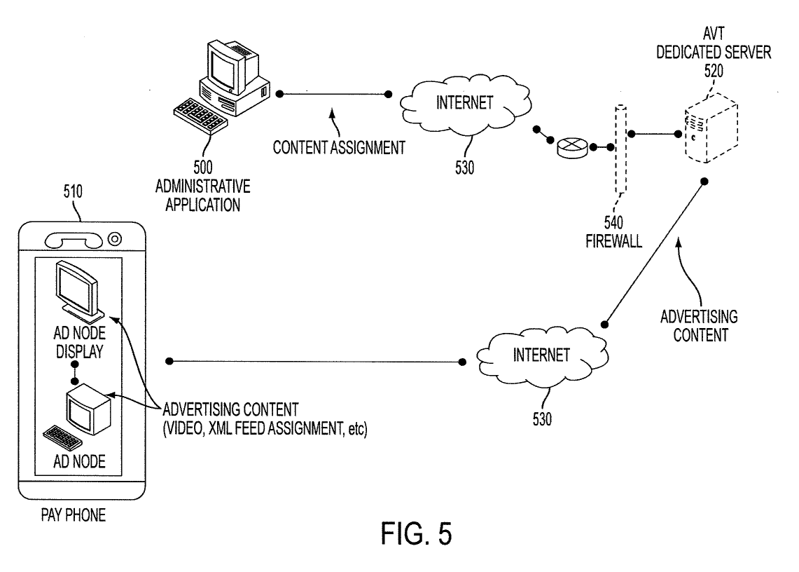

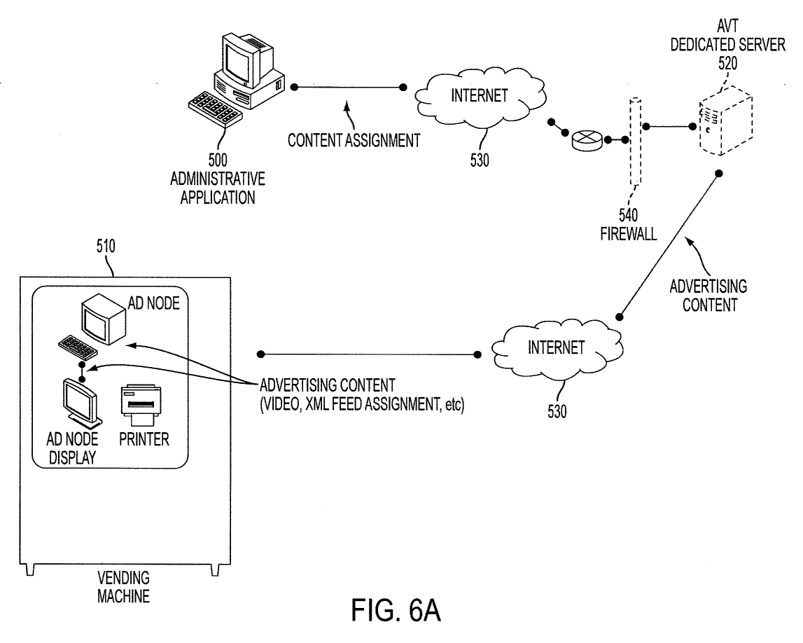

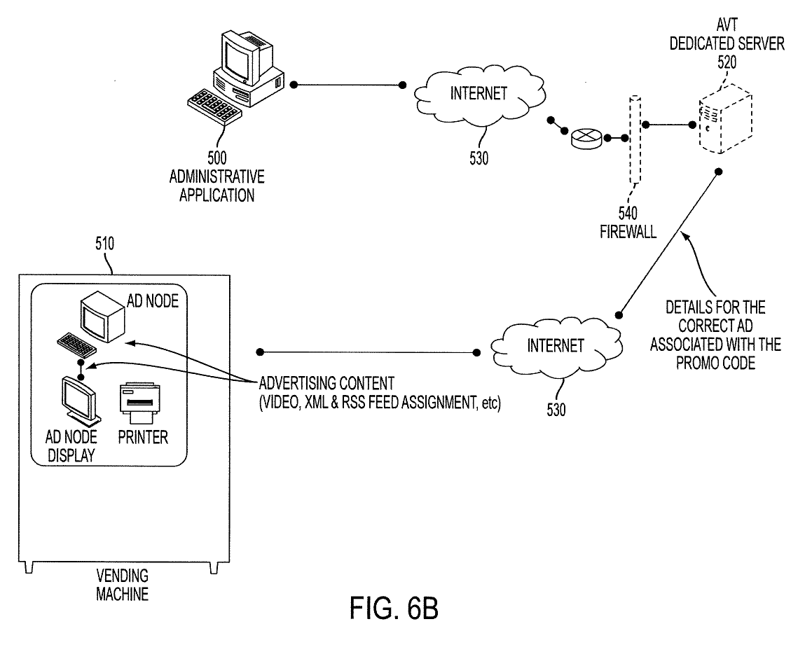

FIGS. 5 and 6A-6B illustrate examples of an interactive advertising system according to embodiments of the invention. The system may include an administrative application 500 deployed on a computer. The administrative application 500 may be used to assign content to delivery points 510. The delivery points 510 may include, for example, pay phones, vending machines and the like. The administrative application 500 may communicate with a server 520 via a network 530, such as the Internet, and other networking devices, such as a firewall 540. The administrative application 500 may provide the content and an identification of the delivery point 510 to receive the content. Alternatively, the administrative application 500 may provide an address or location where the content resides.

The server 520 may receive the identification of the delivery point 510, such as an address or name of the delivery point 510 from the administrative application 500, along with the desired content. The server 520 may retrieve the content, if necessary, from a database, or, as noted above, the content may be provided from the administrative application 500. The server 520 may also obtain the address of the delivery point 510 if needed, for example, from a look-up table or database. The server 520 may communicate with the delivery point 510 via a network 530, such as the Internet or the public switched telephone network 530. The server 520 may provide the desired content to the appropriate delivery point 510. The content may include, for example, advertising content, such as video, XML feed assignment, etc.

The delivery point 510 may include a display to display the content and an input device, for example, a keypad or touch screen to receive information. The delivery point 510 may also include a printer. The content shown on the display may, for example, request a telephone number be entered using the keypad to receive special promotional coupons for products or merchandise at local retailers. The telephone number may then be communicated from the delivery point 510 to the server 520. The server 520 may then initiate the delivery of the coupons and the like to the telephone, for example a mobile device.

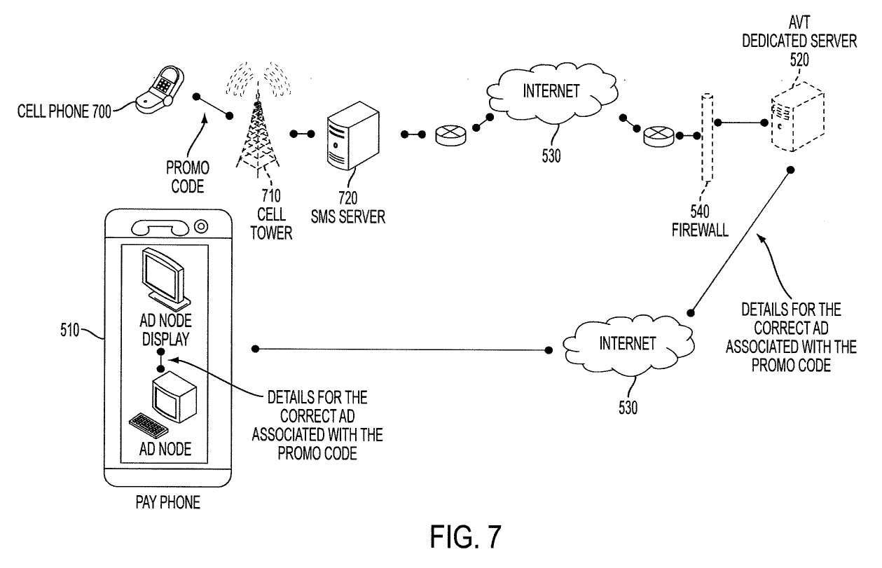

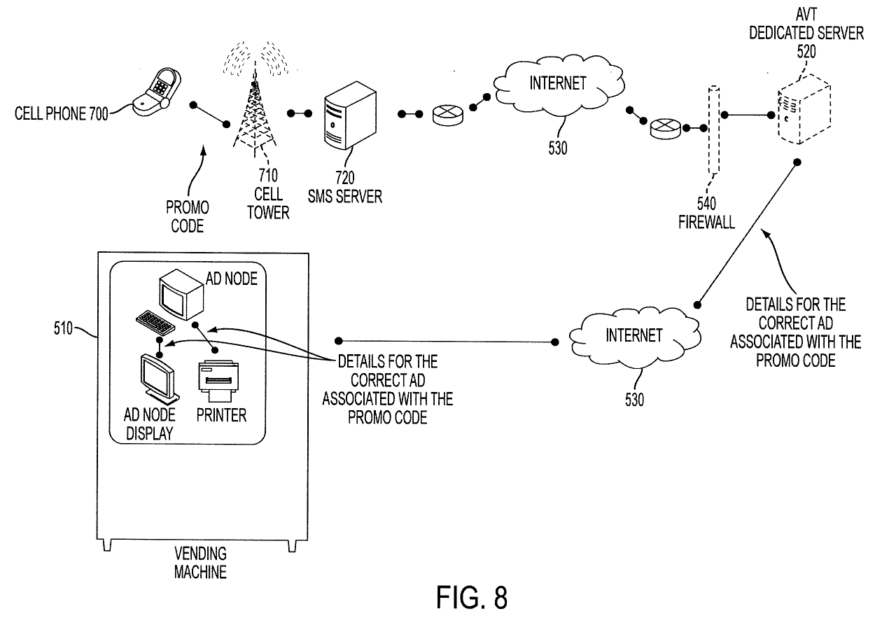

FIGS. 7 and 8 illustrate in more detail the inclusion of a mobile device with the system. The mobile device may communicate using mobile telephone networks 710 and infrastructure with an SMS server 720. The SMS server 720 may communicate with the server 520 via a network 530, such as the Internet. The server 520 may communicate with the delivery point 510 as discussed above in connections with FIGS. 5 and 6A-6B.

As noted above, the delivery point 510 may display an advertisement including a promotion code. For example, the advertisement may state “text this code on your cell phone now to receive 50% off the new Coke ZERO.” The promotion code may be an SMS code. The SMS code may be entered into the mobile device and sent to the server 520, which in turn sends information back to the delivery point 510. The delivery point 510 may be equipped with printer for the purpose of printing out special incentives or coupons through the printer for the user. Again, these coupons can be used for a variety of different products or services within the local community.

The mobile device may also communicate with the delivery point 510. For example, the mobile device may communicate to the delivery point 510 via “Blue Tooth” to complete a transaction or dispense a product. A Wi-Fi hot spot may be integrated into the delivery point 510. In this scenario, the delivery point 510 may be able to produce specific information that will be sent out through blue tooth or other mechanism and received by the Mobile device, such as a cell phone, PDA or other types of PC based phones such as the “I-phone, Blackberry phone, Tri phone and any number of PC or other phones equipped with PC capabilities. Scenarios may also involve the transmission of data via Infra red.

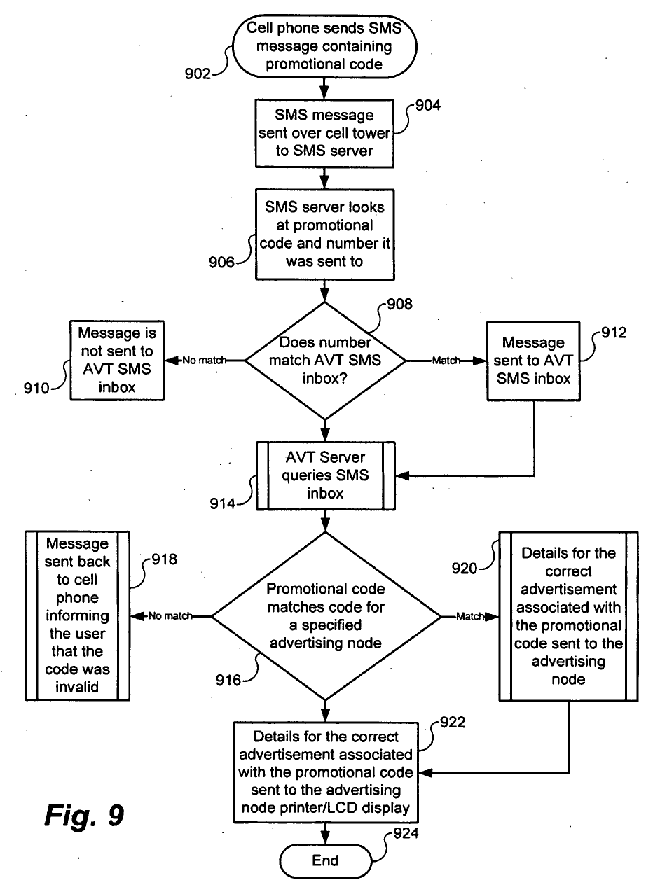

Referring now to FIG. 9, there is shown an exemplary flowchart for managing the advertisement content flow and promotions according to one embodiment of the present invention. The process begins at step 902 where a consumer's cell phone sends a message (e.g., an SMS-type of message) containing a promotional code. That SMS message is then conventionally sent through its local cell tower to an SMS server at step 904. At step 906, the SMS server then looks at the promotional code and telephone number to which it was sent.

A determination is then made at step 908 as to whether the telephone number matches a system SMS inbox. If not, the message is not sent to the system SMS inbox at step 910. However, if there is a match, the message is sent to the system SMS inbox at step 912. Periodically, the dedicated server 412 queries the system SMS inbox at step 914. A determination is then made at step 916 as to whether the promotional code sent at step 902 matches the code for a specified advertising node 414.

If not, a message is sent back at step 918 to the consumer's cell phone to inform the consumer that the promotional code was invalid. However, if there is a match, at step 920 details for the correct advertisement associated with the promotional code is sent to the advertising node 414. Then, at step 922 the details for the correct advertisement associated with the promotional code may be sent to the printer and/or the LCD display of selected advertising node(s) 414.

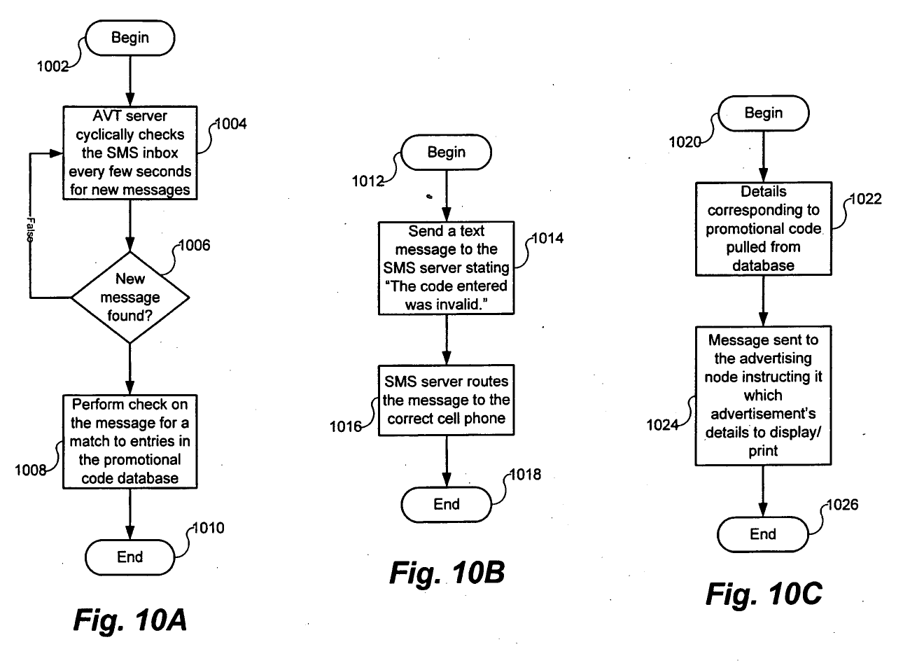

Referring now to FIGS. 10A, 10B, and 10C, exemplary flowcharts for managing the advertisement content flow and promotions according to other embodiments of the present invention will now be explained. At step 1004, the dedicated server 412 cyclically checks the system SMS inbox every few seconds to determine whether it has received any new message. If a new message is found at step 1006, the system performs a check on the message to determine if it contains a match within the promotional code database. If not, the system sends a message at step 1014 to the SMS server stating that “The code entered was invalid.” The SMS server then routes that message to the correct cell phone used by the consumer/user. On the other hand, if the code is a match, details corresponding to the promotional code are retrieved from the database at step 1022. A message is then sent to advertising node 414 at step 1024, instructing it which advertisement details should be printed and/or displayed.

In alternative embodiments, hardwired circuitry may be used in place of or in combination with software instructions to implement features consistent with principles of the invention. Thus, implementations consistent with principles of the invention are not limited to any specific combination of hardware circuitry and software.

Exemplary embodiments may be embodied in many different ways as a software component. For example, it may be a stand-alone software package, a combination of software packages, or it may be a software package incorporated as a “tool” in a larger software product. It may be downloadable from a network, for example, a website, as a stand-alone product or as an add-in package for installation in an existing software application. It may also be available as a client-server software application, or as a web-enabled software application. It may also be embodied as a software package installed on a hardware device.

While various exemplary embodiments have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A system for managing interactive advertisements, comprising:
a plurality of remote vending machines;
an enterprise control center;
a network coupling said enterprise control center and the plurality of remote vending machines;
a touch screen associated with each of the plurality of vending machines; and
means for displaying a plurality of advertisements on said touch screen.

2. The system according to claim 1, wherein said touch screen further comprises means for selecting one of said plurality of advertisements to be displayed.

3. The system according to claim 1, wherein said touch screen further comprises means for paying for items to be vended within the plurality of vending machines.

4. The system according to claim 1, wherein said advertisement display means further comprises means for delivering advertisement content based on the selection of items vended within the plurality of vending machines.

5. The system according to claim 1, further comprising a two-way wireless network coupling said enterprise control center and the plurality of remote vending machines.

6. The system according to claim 1, wherein said network comprises a GSM network.
